(19) United States
(12) Patent Application Publication
(10) Pub. No.: US 2025/0018731 A1
(43) Pub. Date: Jan. 16, 2025

(54) THERMAL PRINT HEAD

(71) Applicant: ROHM CO., LTD., Kyoto-shi (JP)

(72) Inventor: Goro NAKATANI, Kyoto-shi (JP)

(21) Appl. No.: 18/757,042

(22) Filed: Jun. 27, 2024

(30) Foreign Application Priority Data
Jul. 10, 2023 (JP) 2023-112844

(51) Int. Cl. B41J 2/335

(52) U.S. Cl. CPC B41J 2/3353; B41J 2/3355

(57) ABSTRACT

The thermal print head includes a heat generating resistor, a wiring layer that is connected to the heat generating resistor, and a protective layer that covers the heat generating resistor and the wiring layer. The protective layer is an insulating layer to which diamond particles are added.

### CROSS REFERENCE TO RELATED APPLICATIONS

This non-provisional application is based on Japanese Patent Application No. 2023-112844 filed on Jul. 10, 2023 with the Japan Patent Office, the entire contents of which are hereby incorporated by reference.

### BACKGROUND OF THE INVENTION

### Field of the Invention

The present disclosure relates to a thermal print head.

### Description of the Background Art

Japanese Patent Laying-Open No. 2000-153630 discloses a thermal print head that includes a ceramic substrate, a glaze layer, a common electrode, a plurality of individual electrodes, a heat generating resistor, and a protective layer. The protective layer covers the common electrode, the plurality of individual electrodes, and the heat generating resistor.

### SUMMARY

It is an object of the present disclosure to provide a thermal print head that is lower in cost, has improved wear resistance to a print medium, and is capable of preventing the sticking of the print medium.

The thermal print head according to an embodiment of the present disclosure includes a heat generating resistor, a wiring layer that is connected to the heat generating resistor, and a protective layer that covers the heat generating resistor and the wiring layer. The protective layer is an insulating layer to which diamond particles are added.

The foregoing and other objects, features, aspects and advantages of the present invention will become apparent from the following detailed description of the present invention when taken in conjunction with the accompanying drawings.

### BRIEF DESCRIPTION OF THE DRAWINGS

FIG. 1 is a schematic partially enlarged plan view of a thermal print head according to an embodiment;

FIG. 2 is a schematic partially enlarged cross-sectional view of the thermal print head according to the embodiment taken along a cross-sectional line II-II illustrated in FIG. 1;

FIG. 3 is a schematic partially enlarged cross-sectional view of the thermal print head according to the embodiment taken along a cross-sectional line III-III illustrated in FIG. 1; and

FIG. 4 is a flowchart of a method of manufacturing the thermal print head according to the embodiment.

### DESCRIPTION

An embodiment of the present disclosure will be described in detail with reference to the drawings. In the following drawings, the same or corresponding portions are denoted by the same reference numerals, and the description thereof will not be repeated. At least some features in the embodiment to be described below may be arbitrarily combined.

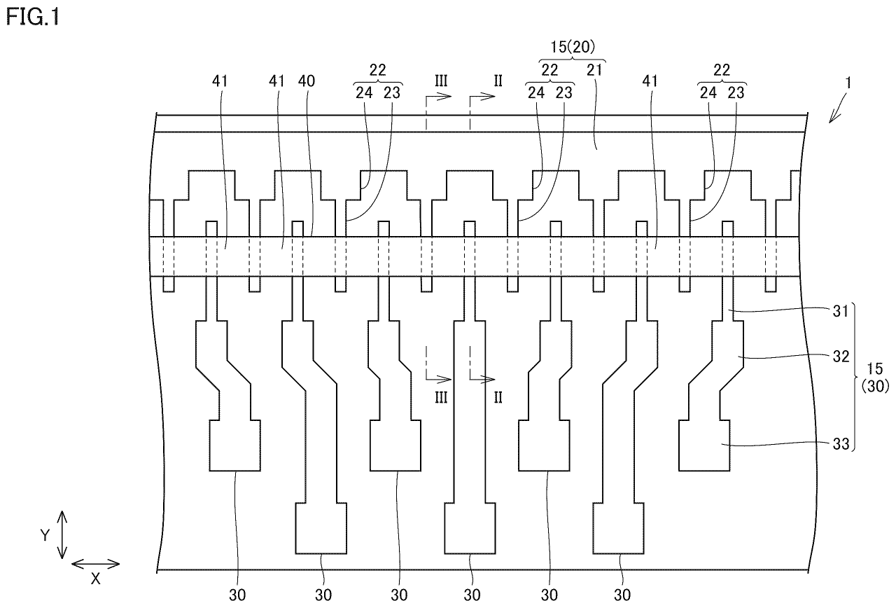

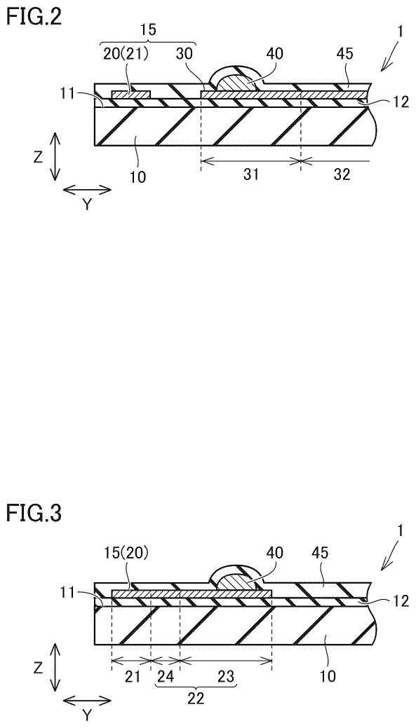

A thermal print head 1 according to an embodiment of the present disclosure will be described with reference to FIGS. 1 to 3. The thermal print head 1 includes a substrate 10, a glaze layer 12, a wiring layer 15, a heat generating resistor 40, and a protective layer 45.

The substrate 10 has a main surface 11. A longer direction of the substrate 10 in a plan view of the main surface 11 is defined as an X direction. The X direction is the main scanning direction. A short direction of the substrate 10 in a plan view of the main surface 11 is defined as a Y direction. The Y direction is the sub-scanning direction. A thickness direction of the substrate 10 perpendicular to both the X direction and the Y direction is defined as a Z direction. The main surface 11 is an end surface in the thickness direction (Z direction) of the substrate 10. The substrate 10 is made of an insulating material such as alumina (Al₂O₃). For example, the substrate 10 is made of ceramics.

The glaze layer 12 is disposed on the main surface 11 of the substrate 10. The glaze layer 12 may accumulate heat generated from the heat generating resistor 40. The glaze layer 12 is made of an insulating material such as glass.

The wiring layer 15 is disposed on the glaze layer 12. The wiring layer 15 is made of, for example, a conductive material such as silver (Ag) or gold (Au). The wiring layer 15 includes a common electrode 20 and a plurality of individual electrodes 30. The common electrode 20 and the plurality of individual electrodes 30 are connected to the heat generating resistor 40.

Specifically, the common electrode 20 includes a connecting portion 21 and a plurality of strip portions 22. The connecting portion 21 extends along the X direction, and the longer direction of the connecting portion 21 is the X direction. The connecting portion 21 is separated from the heat generating resistor 40 in the Y direction. Each of the plurality of strip portions 22 extends toward the heat generating resistor 40 from one side of the connecting portion 21 that faces the heat generating resistor 40. The longer direction of each of the plurality of strip portions 22 is, for example, the Y direction. The plurality of strip portions 22 are arranged at intervals along the X direction.

Each of the plurality of strip portions 22 includes an extending portion 23 and a base portion 24. The base portion 24 is separated from the heat generating resistor 40 in the Y direction. The base portion 24 is connected to the connecting portion 21 and the extending portion 23. The extending portion 23 extends toward the heat generating resistor 40 from an end of the base portion 24 proximal to the heat generating resistor 40. The longer direction of the extending portion 23 is, for example, the Y direction. The extending portion 23 is in contact with the heat generating resistor 40.

The width of the extending portion 23 is smaller than the width of the base portion 24. In the present embodiment, the width of the extending portion 23 refers to the size of the extending portion 23 in the short direction (X direction) of the extending portion 23 in a plan view of the main surface 11 of the substrate 10. The width of the base portion 24 refers to the size of the base portion 24 in the longer direction (X direction) of the heat generating resistor 40 in a plan view of the main surface 11 of the substrate 10. The width of the base portion 24 is the width of an end of the base portion 24 proximal to the extending portion 23.

The plurality of individual electrodes 30 are arranged at intervals along the X direction. Each of the plurality of individual electrodes 30 includes a base portion 32, an extending portion 31, and a pad 33.

The base portion 32 is separated from the heat generating resistor 40 in the Y direction. The base portion 32 is connected to the extending portion 31 and the pad 33. The extending portion 31 extends toward the heat generating resistor 40 from an end of the base portion 32 proximal to the heat generating resistor 40. The longer direction of the extending portion 31 is, for example, the Y direction. The extending portion 31 is disposed between two adjacent extending portions 23. In other words, the extending portions 23 and the extending portions 31 are alternately arranged in the X direction. The extending portion 31 is in contact with the heat generating resistor 40.

The width of the extending portion 31 is smaller than the width of the base portion 32. In the present embodiment, the width of the extending portion 31 refers to the size of the extending portion 31 in the short direction (X direction) of the extending portion 31 in a plan view of the main surface 11 of the substrate 10. The width of the base portion 32 refers to the size of the base portion 32 in the longer direction (X direction) of the heat generating resistor 40 in a plan view of the main surface 11 of the substrate 10. The width of the base portion 32 is the width of an end of the base portion 32 proximal to the extending portion 31.

The pad 33 is bonded with a conductive wire (not shown) that is connected to a terminal of a driver IC (not shown).

In a plan view of the main surface 11 of the substrate 10, the heat generating resistor 40 is disposed between the connecting portion 21 of the common electrode 20 and the base portions 32 of the plurality of individual electrodes 30. The heat generating resistor 40 extends along the X direction, and the longer direction of the heat generating resistor 40 is the X direction. The heat generating resistor 40 is disposed on the extending portions 23 and 31 and the glaze layer 12. In a plan view of the main surface 11 of the substrate 10, the heat generating resistor 40 overlaps with the extending portions 23 and 31. The heat generating resistor 40 is made of a material (e.g., ruthenium oxide) having a higher resistivity than the material constituting the wiring layer 15.

The heat generating resistor 40 includes a plurality of heat generating portions 41. In a plan view of the main surface 11 of the substrate 10, each of the plurality of heat generating portions 41 is a portion of the heat generating resistor 40 sandwiched between the extending portion 23 of the common electrode 20 and the extending portion 31 of the individual electrode 30.

A common potential (for example, a ground potential) is applied to the common electrode 20. A potential is applied to each of the plurality of individual electrodes 30 from the driver IC (not shown). Thus, a current flows through the heat generating portion 41 between the extending portion 31 of the individual electrode 30 to which the potential is applied and the extending portion 23 of the common electrode 20 adjacent thereto, which causes the heat generating portion 41 to generate heat. The heat generated from the heat generating portion 41 is transmitted to a print medium such as heat-sensitive paper, and printing is performed on the print medium.

The protective layer 45 covers the wiring layer 15, the heat generating resistor 40, and the glaze layer 12. The protective layer 45 protects the heat generating resistor 40 and the like from wear, corrosion, oxidation or the like. The protective layer 45 is an insulating layer to which diamond particles are added. For example, the protective layer 45 is a glass layer to which diamond particles are added. The diamond particles are, for example, industrial diamond powders. The thickness of the protective layer 45 is, for example, 1 μm or more and 10 μm or less.

The median diameter (D50) of the diamond particles is 0.5 times or less as large as the thickness of the protective layer 45. The median diameter of the diamond particles may be 0.4 times or less as large as the thickness of the protective layer 45, 0.3 times or less as large as the thickness of the protective layer 45, or 0.2 times or less as large as the thickness of the protective layer 45. The median diameter is a median value of particle diameter distributions obtained by particle diameter analysis described in Japanese Industrial Standards (JIS) 8825:2022. The median diameter (D50) of the diamond particles is, for example, 0.1 μm or more. The median diameter (D50) of the diamond particles may be 0.3 μm or more. The median diameter (D50) of the diamond particles is, for example, 1.5 μm or less. The median diameter (D50) of the diamond particles may be 1.2 μm or less.

The content of the diamond particles in the protective layer 45 is, for example, 1 volume percent or more and 90 volume percent or less. The protective layer 45 is provided with an opening (not shown), and the pad 33 is exposed from the opening of the protective layer 45.

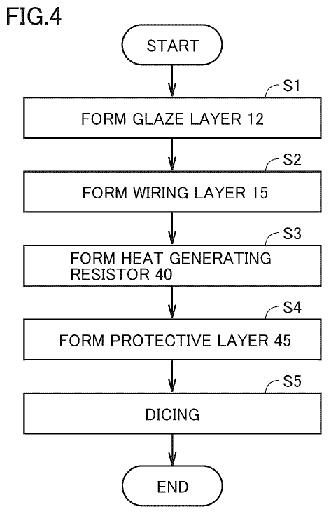

An example method of manufacturing the thermal print head 1 according to the present embodiment will be described with reference to FIG. 4.

Forming a glaze layer 12 on the main surface 11 of the substrate 10 (S1). Specifically, a paste containing glass is coated on the main surface 11 of the substrate 10 by screen printing or the like. The paste is dried and fired to form the glaze layer 12.

Forming a wiring layer 15 on the glaze layer 12 (S2). The wiring layer 15 includes a common electrode 20 and a plurality of individual electrodes 30.

Specifically, a metal layer (not shown) is formed on the glaze layer 12. For example, the metal layer is formed on the glaze layer 12 by screen printing or the like a paste containing a material that constitutes the metal layer, such as a resinate paste containing silver particles. The paste is fired. Thus, the metal layer is formed. Subsequently, the metal layer is patterned by a lithography process to form the wiring layer 15. For example, a resist pattern is formed on the metal layer. The resist pattern is formed by coating a photosensitive resin material on the metal layer and exposing and developing the coated photosensitive resin material. The resist pattern has an opening. The metal layer is exposed from the opening of the resist pattern. The resist pattern is used as a mask to etch a portion of the metal layer that is exposed from the resist pattern. Thus, the metal layer is patterned into the wiring layer 15.

Forming a heat generating resistor 40 (S3). For example, a paste containing a material (for example, glass and ruthenium oxide particles) that constitutes the heat generating resistor 40 is coated on the extending portions 23 and 31 and the glaze layer 12. The paste is fired. Thus, the heat generating resistor 40 is formed.

Forming a protective layer 45 (S4). For example, a paste containing glass, diamond particles and a resin binder is coated on the wiring layer 15, the heat generating resistor 40, and the glaze layer 12 by screen printing or using a dispenser. The paste is dried. The paste is calcined to remove the resin binder. The calcination temperature is about 450° C. The calcination time is about 30 minutes. The paste from which the resin binder is removed is subjected to baking. The baking temperature is, for example, 800° C. or more and 880° C. or less. The baking time is, for example, 3 minutes or more and 15 minutes or less. Since the baking time is short, even if the baking atmosphere is air, the weight reduction of the diamond particles due to the combustion of the diamond particles during the baking can be reduced. If nitrogen atmosphere is selected as the baking atmosphere, the combustion of the diamond particles during the baking can be prevented, and thereby the weight reduction of the diamond particles can be further reduced. Thus, the protective layer 45 is formed.

A laminated body including the substrate 10, the glaze layer 12, the wiring layer 15, the heat generating resistor 40, and the protective layer 45 is diced (S5). For example, the laminated body is cut by irradiating the laminated body with laser light. The laminated body is diced into a plurality of thermal print heads 1. Thus, the thermal print head 1 is obtained.

In another modification of the present embodiment, the extending portions 23 and 31 may extend in an oblique direction with respect to the longer direction of the heat generating resistor 40.

The effect of the thermal print head 1 of the present embodiment will be described.

The thermal print head 1 of the present embodiment includes a heat generating resistor 40, a wiring layer 15 that is connected to the heat generating resistor 40, and a protective layer 45 that covers the heat generating resistor 40 and the wiring layer 15. The protective layer 45 is an insulating layer to which diamond particles are added.

Since the protective layer 45 contains diamond particles, the hardness of the protective layer 45 is improved. Thus, the wear resistance of the protective layer 45 to a printing medium such as heat-sensitive paper is improved. In addition, since the protective layer 45 contains diamond particles, the contact of the printing medium with the protective layer 45 becomes smoother, which makes it possible to prevent the printing medium from sticking to the protective layer 45.

In a comparative example in which the entire protective layer is made of diamond-like carbon (DLC), the material cost of the protective layer is high. In addition, the protective layer made of diamond-like carbon (DLC) needs to be formed using a manufacturing method having a higher cost such as a chemical vapor deposition (CVD) method. In contrast, in the present embodiment, the protective layer 45 is an insulating layer to which diamond particles are added. Since only a proportion of the protective layer 45 is made of diamond particles, the material cost of the protective layer 45 is reduced. In addition, the protective layer 45 may be formed using a lower cost manufacturing method such as screen printing or using a dispenser. Therefore, the cost of the thermal print head 1 of the present embodiment is further reduced.

When the thermal print head 1 is in operation, the temperature of a portion of the protective layer 45 on the heat generating resistor 40 usually reaches about 300° C., and may temporarily reach about 700° C. However, diamond particles do not decompose even at such a high temperature and can withstand such a high temperature.

In the thermal print head 1 of the present embodiment, the median diameter of the diamond particles is 0.5 times or less as large as the thickness of the protective layer 45.

Therefore, the surface of the protective layer 45 can be prevented from becoming rough. The contact of the print medium with the protective layer 45 becomes smoother, which improves the printing quality.

In the thermal print head 1 of the present embodiment, the content of the diamond particles in the protective layer 45 is not less than 1 volume percent and not more than 50 volume percent.

Since the content of the diamond particles in the protective layer 45 is 1 volume percent or more, the wear resistance of the protective layer 45 to the printing medium is improved, and the printing medium can be more reliably prevented from sticking to the protective layer 45. Since the content of the diamond particles in the protective layer 45 is 1 volume percent or more and 90 volume percent or less, the surface of the protective layer 45 can be prevented from becoming rough. The contact of the print medium with the protective layer 45 becomes smoother, which improves the printing quality.

In the thermal print head 1 of the present embodiment, the diamond particles are industrial diamond powder.

Therefore, the cost of the protective layer 45 is significantly reduced as compared with the case where the protective layer 45 is made of diamond-like carbon (DLC), for example. Thereby, the cost of the thermal print head 1 can be prevented from increasing.

Hereinafter, aspects of the present disclosure will be summarized.

(Aspect 1)

A thermal print head includes:
a heat generating resistor;
a wiring layer that is connected to the heat generating resistor;
a protective layer that covers the heat generating resistor and the wiring layer,
the protective layer is an insulating layer to which diamond particles are added.

(Aspect 2)

The thermal print head according to Aspect 1, wherein a median diameter of the diamond particles is 0.5 times or less as large as a thickness of the protective layer.

### (Aspect 3)

The thermal print head according to Aspect 1 or 2, wherein a content of the diamond particles in the protective layer is 1 volume percent or more and 90 volume percent or less.

### (Aspect 4)

The thermal print head according to any of Aspects 1 to 3, wherein the diamond particles are industrial diamond powders.

It should be understood that the embodiment disclosed herein are illustrative and non-restrictive in all respects. The scope of the present disclosure is defined not by the above description but by the scope of the claims, and is intended to include all modifications equivalent in meaning and scope to the claims.

### DESCRIPTION OF SYMBOLS

1: thermal print head; 10: substrate; 11: main surface; 12: glaze layer; 15: wiring layer; 20: common electrode; 21: connecting portion; 22: strip portion; 23, 31: extending portion; 24, 32: base portion; 30: individual electrode; 33: pad; 40: heat generating resistor; 41: heating generating portion; 45: protective layer.

What is claimed is:

1. A thermal print head comprising:
a heat generating resistor;
a wiring layer that is connected to the heat generating resistor;
a protective layer that covers the heat generating resistor and the wiring layer,
the protective layer being an insulating layer to which diamond particles are added.

2. The thermal print head of claim 1, wherein
a median diameter of the diamond particles is 0.5 times or less as large as a thickness of the protective layer.

3. The thermal print head of claim 1, wherein
a content of the diamond particles in the protective layer is 1 volume percent or more and 90 volume percent or less.

4. The thermal print head of claim 2, wherein
a content of the diamond particles in the protective layer is 1 volume percent or more and 90 volume percent or less.

5. The thermal print head according to claim 1, wherein
the diamond particles are industrial diamond powders.

6. The thermal print head according to claim 2, wherein
the diamond particles are industrial diamond powders.

7. The thermal print head according to claim 3, wherein
the diamond particles are industrial diamond powders.
